(19) United States
(12) Patent Application Publication
(10) Pub. No.: US 2024/0047087 A1
(43) Pub. Date: Feb. 8, 2024

(54) Method of Enhancing Ignition Characteristics of ICF Targets Based on High-Z Shells

(71) Applicants: Robert O. Hunter, JR., Aspen, CO (US); Eric W. Cornell, Colorado Springs, CO (US)

(72) Inventors: Robert O. Hunter, JR., Aspen, CO (US); Eric W. Cornell, Colorado Springs, CO (US)

(73) Assignee: Innoven Energy LLC, Columbia, MO (US)

(21) Appl. No.: 17/879,707

(22) Filed: Aug. 2, 2022

(51) Int. Cl. G21B 1/11; G21B 1/03

(52) U.S. Cl. CPC G21B 1/11; G21B 1/03

(57) ABSTRACT

A system and method of enhancing implosion characteristics of an Inertial Confinement Fusion (ICF) target by tailoring the shell such that at the appropriate temperature, the shell allows the energy in the central region to escape. These ICF targets are more efficient than conventional targets in that they utilize the high-Z shell to contain radiation losses from the fusion fuel core. In some embodiments, the shell is designed such that at the appropriate temperature, the shell allows the core radiation to escape. As a result, there is less energy lost. Therefore, the temperature rise in the core is enhanced which aides in the ignition and burn efficiency of the fusion fuel. Further, the ICF targets as described have substantially reduced computational requirements for design and analysis making them more desirable than conventional ICF targets.

### BACKGROUND

Nuclear fusion by inertial confinement, Inertial Confinement Fusion (“ICF”), utilizes nuclear fusion reactions to produce energy. In most types of ICF systems, an external drive mechanism, such as a laser, delivers energy to a target containing nuclear fusion fuel. The target is designed to use this energy to compress, heat and ignite the fusion fuel within the target. If a sufficient amount of fuel is compressed sufficiently and heated sufficiently, a self-sustaining fusion reaction can occur in which energy produced by fusion reactions continues to heat the fuel. This is generally referred to as “ignition.” The inertia of the compressed fuel can keep it from expanding long enough for significant energy to be produced before expansion of the fuel and the resultant cooling terminates the fusion reaction. Most conventional ICF target designs involve a spherical target which is imploded symmetrically from all directions, relying on the stagnation of the inwardly-accelerated fuel at the center of the sphere to produce the required densities and temperatures.

Production of the very high temperatures and densities required for fusion ignition may require a substantial amount of energy. The exact amount of energy required depends on the specific target design in use. In order to be useful for energy generation, the target must be capable of producing more energy from fusion reactions than was required to ignite it. In addition, the amount of energy required by the target must be physically and/or economically realizable by the drive mechanism being used.

For this reason, conventional ICF target designs have focused on achieving the required temperatures and densities as efficiently as possible. These designs are often complex in their construction and operation. They are also sensitive to imperfections in the target's manufacturing, as well as any non-uniformity in the delivery of energy to the target from the drive mechanism. Imperfection and non-uniformity can lead to asymmetry in the target's implosion, which may potentially reduce the densities and temperatures achieved below the threshold required for ignition. Furthermore, successful operation of these complex designs often requires achieving a precise balance between multiple competing physical processes, many of which are poorly understood and difficult to model. When actually constructed and deployed, these complex ICF target designs often fail to perform as their designers intended, and to date none have actually succeeded in producing ignition or the desired fuel conditions.

The National Ignition Facility (“NIF”) target exemplifies the conventional approach. The NIF target involves an outer ablator shell comprising primarily plastic or beryllium with various dopants surrounding a shell of cryogenic deuterium and tritium (D-T) ice with a central void filled with low-density D-T gas. The NIF target is placed in a cylindrical hohlraum. In operation, a laser having of 192 separate beamlines, with a total energy delivered to the hohlraum of up to 1.8 MJ, illuminates a number of spots on the inner surface of the hohlraum, producing a radiation field which fills the hohlraum. The radiation field ablates the ablator layer, and the reactive force of the ablation implodes the target. The laser pulse is 18 nanoseconds long and is temporally tailored in order to drive a series of precisely-adjusted shocks into the target. The timing and energy level of these shocks are adjusted in order to achieve a quasi-isentropic, efficient implosion and compression of the shell of D-T fuel. Stagnation of these shocks and inward-moving material at the center of the target is intended to result in the formation of a small “hotspot” of fuel, at a temperature of roughly 10 keV and a ρr of approximately 0.3 g/cm², surrounded by a much larger mass of relatively cold D-T fuel. It is intended that the fuel in the “hotspot” will ignite with a fusion burn propagating into the cold outer shell. However, at the time of this disclosure, the NIF target has failed to ignite.

### BRIEF SUMMARY

Inertial Confinement Fusion (“ICF”) targets with an enhanced efficiency for their

utilization are disclosed. These ICF targets may be more efficient than conventional targets that utilize the shell to contain radiation losses from the fusion fuel core. In some embodiments, the shell is designed such that at the appropriate temperature, the shell allows the core radiation to escape. This may result in less energy loss and more efficiency in the burning of the fusion fuel. Further, the targets as described may have substantially reduced computational requirements for design and analysis making them more desirable than conventional ICF targets.

### BRIEF DESCRIPTION OF THE DRAWINGS

FIG. 1 illustrates a cross-section of an ICF target, according to some

embodiments.

FIG. 2 shows a flowchart illustrating a process for imploding and igniting an ICF target, according to some embodiments.

FIG. 3 illustrates an ICF target suspended within a hohlraum and ICF reaction chamber, according to some embodiments.

### DETAILED DESCRIPTION

Inertial Confinement Fusion reactor chambers can be designed to contain an ICF target being imploded and capture the resulting energy output from the reaction in the forms of neutrons, radiation, and/or debris. Such chambers can generally include a combination of neutron moderating layers, neutron absorbing layers, neutron shielding layers, radiation capturing layers, sacrificial layers, shock absorbers, tritium breeding layers, tritium breeders, coolant systems, injection nozzles, inert gas injection nozzles, sputterers, sacrificial coating injection nozzles, beam channels, target supporting mechanism, and/or purge ports, among others. Generally speaking, neutron moderating material can be constructed from graphite and may be naturally or artificially doped, combined, allowed, and/or mixed with neutron absorbing material and/or have a thickness of one or more neutron mean free path lengths (e.g., 0.3-1.0 m). Neutron absorbing material may include boron, cadmium, lithium, etc. Radiation tiles or layers can be disposed throughout the chamber to absorb radiation from the reaction.

Such cylindrical chambers can be used with both directional and omni-directional targets. For instance, for use with directional targets where neutrons are not directed and radiations and debris are directed along the longitudinal length of the cylinder, a chamber can have neutron moderating and/or absorbing material concentrated near the center of the cylinder, and radiation and debris collecting material can be concentrated in the outer sections of the cylindrical chamber. Various other specific embodiments and configurations are described.

The term “approximately” and “about” refers a given value ranging plus/minus 15%. For example, the phrase “approximately 10 units” is intended to encompass a range of 8.5 units to 11.5 units.

The term “atom” may refer to a particle of matter, composed of a nucleus of tightly-bound protons and neutrons with an electron shell. Each element has a specific number of protons.

The term “neutron” may refer to a subatomic particle with no electrical charge. Their lack of a charge means that free neutrons generally have a greater free range in matter than other particles.

The term “proton” may refer to a subatomic particle with a positive electrical charge.

The term “electron” may refer to a subatomic particle with a negative electrical charge, exactly opposite to that of a proton and having less mass than a proton and a neutron. Atoms under ordinary conditions have the same number of electrons as protons, so that their charges cancel.

The term “isotope” may refer to atoms of the same element that have the same number of protons, but a different number of neutrons. Isotopes of an element are generally identical chemically, but may have different probabilities of undergoing nuclear reactions.

The term “ion” may refer to a charged particle, such as a proton or a free nucleus.

The term “plasma” may refer to the so-called fourth state of matter, beyond solid, liquid, and gas. Matter is typically in a plasma state when the material has been heated enough to separate electrons from their atomic nuclei.

The term “Bremsstrahlung radiation” may refer to radiation produced by interactions between electrons and ions in a plasma. One of the many processes that can cool a plasma is energy loss due to Bremsstrahlung radiation.

The product “ρr” may refer to the areal mass density of a material. This term may refer to a parameter that can be used to characterize fusion burn. This product is expressed in grams per centimeter squared, unless otherwise specified.

The term “runaway burn” may refer to a fusion reaction that heats itself and reaches a very high temperature. Because the D-T reaction rate increases with temperature, peaking at 67 keV, a D-T plasma heated to ignition temperature may rapidly self-heat and reach extremely high temperatures, approximately 100 keV, or higher.

The term “burn fraction” may refer to the percentage of fusion fuel consumed during a given reaction. The greater the burn fraction, the higher the energy output.

The term “convergence” may refer to how much a shell (or material) has been compressed radially during implosion. For instance, a shell that starts with a radius of 0.1 cm, R, and is compressed to a radius of 0.01 cm, R_{c}, during implosion has a convergence of 10. That is,

$$C = \frac{R}{{R}_{c}}$$

Nuclear fusion may refer to a type of reaction that occurs when certain atomic nuclei collide. In most of these reactions, two light nuclei combine, producing heavier nuclei and/or nuclear particles. In the process, some of the energy in the nuclear bonds holding the nuclei together is released, usually settling in the form of thermal energy (heat) in the material surrounding the reacting particles. These reactions only occur between atomic nuclei that are very energetic, such as those that have been heated to a high temperature to form a plasma. The specific temperatures vary between reactions. The reaction between deuterium and tritium, two hydrogen isotopes, is generally considered to require the lowest temperature for ignition. As other fusion reactions require higher temperatures, most nuclear fusion power concepts envision the use of D-T fuel.

Two challenges in using nuclear fusion to produce power are referred to as ignition and confinement. Achieving ignition requires heating a plasma of fusion fuel until it becomes hot enough to heat itself, meaning the energy released from fusion reactions exceeds the energy lost through various processes, such as Bremsstrahlung radiation and hydrodynamic expansion. The temperature at which this occurs is known as the “ignition temperature,” which for D-T fuel can range from 2-10 keV, depending on the physical properties of the plasma. After ignition, self-heating in the fuel can cause it to reach temperatures of 100 keV or more.

Once fuel has been ignited, confinement may refer to the challenge of keeping the fuel from expanding (thus cooling and ceasing to burn) long enough for it to produce the desired amount of energy: at least as much energy as was required to ignite the fuel and keep it confined—and hopefully significantly more. While heating the fuel to ignition is simply a matter of delivering energy to it, confinement is more challenging. There is no known way to confine a plasma heated to ignition temperature or beyond with a simple mechanical system. Any solid substance, such as the metal wall of a container, that comes into contact with a fusion plasma would either become instantly vaporized, would drastically cool the plasma and stop the burn itself, or both.

The method of confinement uses a magnetic field to keep the fuel from expanding. This is referred to as Magnetic Confinement Fusion (MCF). Magnetic confinement has many inherent difficulties and disadvantages, and economical power generation from an MCF facility appears decades away.

Another approach takes advantage of how the characteristics of fusion burn change with fuel amount and density. At ordinary densities and practicable amounts, a D-T plasma heated to ignition temperature will disassemble (expand and stop burning) before producing anywhere near the energy required to originally heat it. However, as the density of a given amount of fuel is increased, the rate at which the fuel will burn increases faster than the rate at which it will expand. This means that, if the fuel can be compressed sufficiently before heating it, the fuel's own resistance to motion (inertia) will keep it from expanding long enough to yield a significant amount of energy. This approach is referred to as Inertial Confinement Fusion (ICF).

The term “Z” refers to the atomic number of an element, i.e., the number of protons in the nucleus. The term “A” refers to the atomic mass number of an element, i.e., the number of protons and neutrons in the nucleus. At the pressures and temperatures involved in imploding and burning ICF targets, specific material properties that one observes in everyday life (hardness, strength, room-temperature, thermal conductivity, etc.) may be irrelevant, and the hydrodynamic behavior of a material can depend most strongly on the material's average atomic number, atomic mass number, and solid density.

As such, in discussing material requirements in ICF targets, it is convenient to discuss classes of material. For the purposes of the following discussion, the term “low-Z” will refer to materials with an atomic number of 1-5 (hydrogen to boron); the term “medium-Z” will refer to materials with an atomic number of 6-47 (carbon to silver); and the term “high-Z” will refer to materials with an atomic number greater than 48 (cadmium and above). Unless otherwise stated, the use of these terms to describe a class of material for a specific function is intended only to suggest that this class of material may be particularly advantageous for that function, and not (for instance) that a “high-Z” material could not be substituted where a “medium-Z” material is suggested, or vice-versa.

The differing solid densities of materials with similar-Z may also important for certain design criteria in some embodiments.

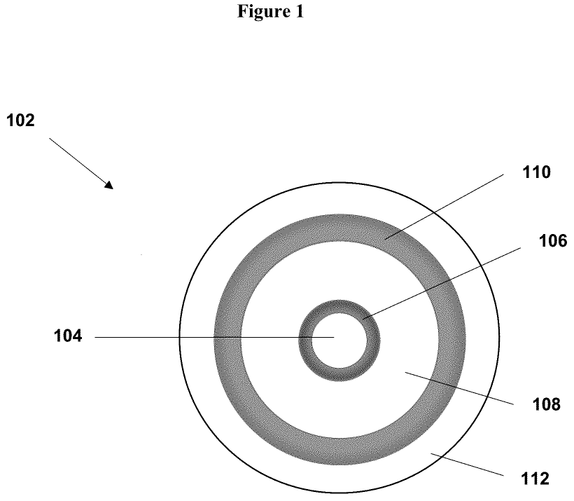

FIG. 1, illustrates an ICF target 102. In the center of ICF target 102 may be central region 104. Central region 104 is a centrally located spherical fusion fuel region and may comprise deuterium-tritium (D-T) gas, with a low density of approximately 0.22 g/cc. A density higher than this would make deuterium-tritium a solid. Other combinations of materials may be used for central region 104 such as pure deuterium, lithium deuteride, lithium tritide, D-T with a reduced fraction of tritium, or any other fusion fuel or combination of fuels. The density of fusion fuel in central region 104 may be increased or decreased. Gaseous D-T, liquid D-T, or solid D-T may also be used. Surrounding central region 104 may be inner shell region 106, which may be a spherical shell comprising a high-Z material. Inner shell 106 may be made of a variety of materials including but not limited to: tungsten, Uranium-238, or Thorium-232. By definition, U-238 is a non-fissile, fissionable material. Use of high-Z materials, or materials with a high opacity to radiation in the approximately 0.5-2.5 keV range, may be advantageous, but other materials may be substituted as well. One could use a medium-Z material (such as carbon) or low-Z material (such as copper) for the inner shell 106, one could even mix a low-Z material with a high-Z material or a low-Z material with a medium-Z material. Optionally, surrounding inner shell region 106 may be outer fuel region 108, which may be a spherical shell comprising a low-Z material. Inner shell 106 and outer shell 110 may comprise a plurality of materials such as two or more materials arranged in a laminated (e.g., bonded or adhered together), mixed (e.g., blended or dispersed throughout), or layered (e.g., arranged one on top of another) fashion. The ICF target 102 may be scaled up or down in size as needed to achieve the critical temperatures as discussed below. The radius of central region 104 may be increased or decreased. Thickness of inner shell 106 and outer fuel region 108 may be increased or decreased.

Surrounding outer shell 110 may be an optional ablator region 112, a spherical concentric casing. Ablator region 112 may be manufactured from a variety of materials or combinations of a plurality of materials. Outer Shell 110 may comprise two or more materials arranged in a laminated (e.g., bonded or adhered together), mixed (e.g., blended or dispersed throughout), or layered (e.g., arranged one on top of another) fashion. Low-Z materials may be advantageous as ablators, but other materials may be used such as high-Z materials. Ablator region 112 may be doped with certain materials in order to achieve favorable ablation characteristics and close “holes” in the radiation opacity. The thickness of ablator region 112 may be increased or decreased. The thickness of ablator region 112 may affect the pressure of the converging shock when it arrives at outer shell 110 and/or inner shell 106, the gain of the target, the sensitivity of the target to implosion asymmetry, and potentially other properties. The use of a radiation hydrodynamics code may be advantageous in optimizing the design of ICF target 102, including the composition and dimensional relations of the components discussed.

In some embodiments, the designer may choose a combination of dimensions, materials, densities, and laser parameters that does not lead to the conditions required for ignition being reached in ICF target 102 in operation. Such targets may be advantageous for experimental purposes, for validation of computational design codes, for testing of diagnostic and monitoring equipment, or for use in ICF target chambers that may have limited ability to contain the output of fusion reactions.

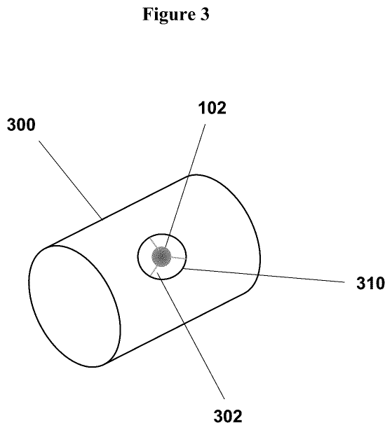

FIG. 3, illustrates ICF Target 102 concentrically suspended within hohlraum 300 by various support means 302 including but not limited to: stalks, fibers, membranes, filaments, supports, or threads. The plurality of support means 302 may be used as needed, to support and suspend ICF Target 102 within hohlraum 300. Hohlraum 300 can also be filled with various materials such as a low-density, low-Z foam as the support means 302 to support ICF target 102. ICF Target 102 and hohlraum 300 may then be placed in ICF reaction chamber 310 to be ignited.

In some embodiments, when a shock driven through ablator region 112 reaches outer shell 110, the outer shell may be accelerated inwardly and may reach a peak inward velocity of approximately 2.9×10⁷ cm/s. The inward acceleration of outer shell 110 may drive a shock into inner shell 106 and central region 104. The inward motion of outer shell 110 and the convergence of the shock that outer shell 108 and inner shell 106 launches, may result in compression and heating of fusion fuel within central region 104. The peak areal density (ρr) reached in the fusion fuel of central region 104 may be approximately 0.75 g/cm². During a typical implosion, the areal density (ρr) of the shell may be in the range of 5-10 g/cm² for D-T fusion fuel. At an ignition temperature of around 2.5 Kev, the thermal depth of the wave penetrating the shell is ρrₜₕ≅0.1-0.2 g/cm².

Because of this relatively high areal density (ρr), the dominant energy loss mechanism of the fusion fuel may be radiation emission. At an appropriate temperature, outer shell 110 (or inner shell 106 when applicable) bleaches out and allows the radiation to escape from central region 104. We can calculate the temperature at which the energy loss due to Bremmstrahlung becomes less than the energy loss due to the radiation heat loss into the walls.
P_{B}=^{P}Bremmstrahlung=3×10¹⁶ W/cm³
ρ²\sqrt{Tk} where ρ is in g/cm³
Tₖ=temperature of the electrons in units of kiloelectron volts (1.160×10⁷° Kelvin=1 KeV)
P_{R}=^{P}radiation=10¹⁷ W/cm²
Tₖ⁴4πArₒ², where A is the absorption level of the incident radiation (usually 0.05-0.10 for a typical target)
   rₒ is the inner edge of the shell.

$$\frac{{P}_{R}}{{P}_{8}} = \frac{{T}_{K} 7 / 2}{ρ ( ρ r )}$$

For P_{B}<P_{Rad},

$$\frac{{T}_{KC} 7 / 2}{( ρ r ) ρ} < 1$$

At this critical temperature (T_{KC}) the wall would bleach and let the radiation leave. As an example,
ρr=2 g/cm², ρ=10² g/cm³, T_{KC}=4.9 KeV
ρr=0.4 g/cm², ρ=10² g/cm³, T_{KC}=3.0 KeV

Therefore, the areal density of the shell is reduced while reducing only the thickness of the shell, and thus the critical temperature for bleaching the shell is also reduced. As shown above, around these temperatures, a low areal density (ρr_{TH}≅0.1-0.2 g/cm²) of the shell would be penetrated and the thermal loss would decrease.

While conventional ICF targets with a high-Z shell compressing and heating a fusion fuel core may utilize the shell to contain radiation losses from the fuel core; this invention tailors the shell so that at the appropriate temperature the radiation containing component of the shell bleaches out and lets the core radiation escape. This may result in less energy loss to both the heat capacity of the radiation field and the containing wall that would otherwise obtain; enhancing temperature rise in the core; and aiding in ignition and efficient burn of the fusion fuel.

The implosion process described above may have numerous advantages relative to conventional ICF targets, such as a NIF-style target. In some embodiments, ICF target 102 is configured such that there is less energy loss to both the heat capacity of the radiation field and the containing wall. The implosion allows for higher temperatures in the fusion fuel of the central region 104. As such, the amount of energy required for the fuel to ignite is less, and therefore, the drive energy requirement is reduced and all of this may result in a more efficient burn of the fusion fuel in central region 104.

The ignition process of this embodiment also has numerous advantages relative to that utilized by conventional ICF targets. Because of the large fuel mass and the high-Z inner shell 106 surrounding fusion fuel in central region 104, the ignition temperature of the fuel 104 may be approximately 2.5-3 keV, as opposed to the approximately 10 keV required for ignition of a NIF-style target.

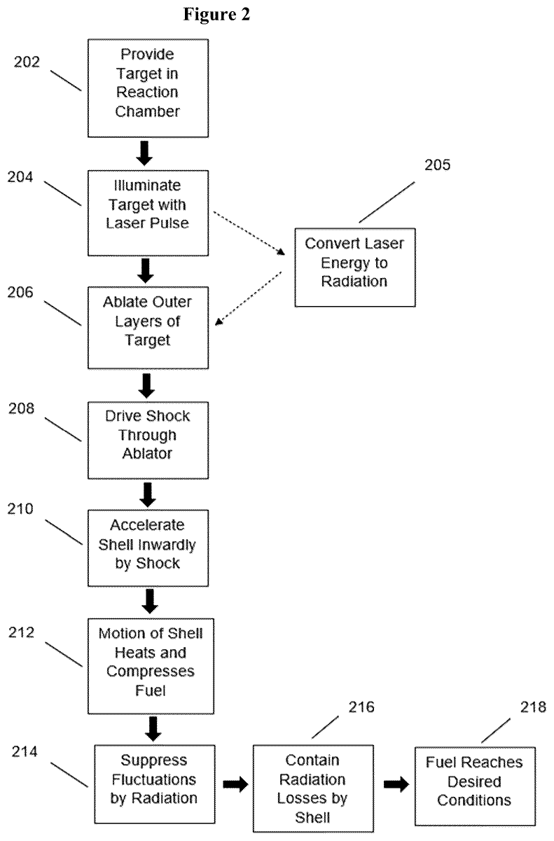

FIG. 2 illustrates a flowchart of a method for imploding an ICF target, according to some embodiments. In step 202, a target assembly (labeled as “target” on FIG. 2) as described above, comprising at least an ablator, shell, and fuel region, optionally enclosed by a hohlraum, may be positioned in a suitable ICF reaction chamber. In step 204, the target assembly (ICF target and/or hohlraum) may be illuminated with a laser pulse. Optionally, in step 205, the laser energy can be converted to x-ray radiation within hohlraum to indirectly drive the target and potentially increase the uniformity of the target implosion. This step can be omitted if the ICF target is directly driven by the laser beams (e.g., laser beam directly/immediately reaches ICF target without any interference of other structures such as propellants or additional surfaces).

In step 206, the outer layers of the ICF target may be ablated either directly by the laser energy, or indirectly by the radiation produced in step 205. In step 208, a single shock wave may be driven inwardly through the ablator region by the ablation process initiated in step 206. In step 210, the shockwave generated in step 208 may hit the shell and impulsively accelerate it inwardly. In step 212, the inward motion of the shell initiated in step 210 may heat and compress the fuel. In step 214, fluctuations and non-uniformities in the density and pressure profiles within the fuel may be damped by interaction with the radiation field in the fuel. As a result, the entire volume of the fuel may be heated nearly uniformly, and the fuel may remain nearly isothermal. In step 216, the shell may act to contain and reduce radiation losses from the fuel. In step 218, the fuel may reach the desired conditions, with this step occurring earlier than it otherwise would due to the suppression of radiation losses in step 216. In some embodiments, this may include the conditions required for ignition, which may include a ρr of at least approximately 0.6 g/cm² and a temperature of at least approximately 2.5 keV. The exact conditions required for ignition at this step may vary between embodiments and utilizations of this process. The desired conditions may also represent conditions of density and temperature below the threshold for ignition, e.g., for experimental or validation purposes as discussed above.

Additionally, the embodiments discussed in this application are intended to be exemplary only, and not an exhaustive list of all possible variants of the invention. Certain features discussed as part of separate embodiments may be combined into a single embodiment. Additionally, embodiments may make use of various features known in the art but not specified explicitly in this application.

Embodiments can be scaled-up and/or scaled-down in size, and relative proportions of components within embodiments can be changed as well. The range of values of any parameter (e.g. size, thickness, density, mass, etc.) of any component should not be construed as a limit on the maximum or minimum value of that parameter unless specifically described as such.

While advantages and characteristics of certain embodiments are mentioned, this should not be interpreted as a requirement that all embodiments display these advantages or characteristics. The previous description provides embodiments only, and is not intended to limit the scope, applicability, or configuration of the disclosure. Rather, the previous description of the embodiments will provide those skilled in the art with an enabling description for implementing one or more embodiments. It is understood that various changes may be made in the function and arrangement of elements without departing from the spirit and scope of the invention. Several embodiments were described herein, and while various features are ascribed to different embodiments, it should be appreciated that the features described with respect to one embodiment may be incorporated within other embodiments as well. By the same token, however, no single feature or features of any described embodiment should be considered essential to every embodiment of the invention, as other embodiments of the invention may omit such features.

Specific details are given in the previous description to provide a thorough understanding of the embodiments. However, it will be understood by one of ordinary skill in the art that the embodiments may be practiced without these specific details. While detailed descriptions of one or more embodiments have been given above, various alternatives, modifications, and equivalents will be apparent to those skilled in the art without varying from the spirit of the invention. Moreover, except where clearly inappropriate or otherwise expressly noted it should be assumed that the features, devices and/or components of different embodiments may be substituted and/or combined. Thus, the above description should not be taken as limiting the scope of the invention.

1. A system for igniting an Inertial Confinement Fusion (ICF) target, the system comprising:
an ICF target comprising:
a central region, wherein said central region receives a fusion fuel mixture;
a first shell, wherein said first shell comprises a plurality of materials having a Z greater than 48 and having an areal density of less than approximately 4 g/cm²;
an outer shell, wherein said outer shell surrounds said first shell;
supporting means to support said ICF target within a hohlraum; and
means for reducing a temperature at which the first shell is bleached to be less than approximately 4.9 KeV.

2. The system of claim 1, wherein the ICF target further comprises a second shell concentrically located between said first shell and said outer shell.

3. The system of claim 2, wherein the first shell and the second shell of the ICF target further comprises a plurality of materials, in a laminated, mixed or layered fashion.

4. The system of claim 3, wherein the second shell further comprises a material having a Z of 5 and below.

5. The system of claim 4, wherein the first shell of the ICF target further comprises an areal density of less than approximately 0.4 g/cm².

6. The system of claim 5, further comprising: means for reducing a temperature at which the first shell is bleached to be less than approximately 3.0 KeV.

7. The system of claim 6, wherein the first shell of the ICF target further comprises an areal density of less than approximately 0.2 g/cm².

8. The system of claim 3, wherein the material of the first shell is non-fissile fissionable material.

9. The system of claim 3, wherein the material of the first shell is tungsten.

10. The system of claim 1, wherein the ICF target is only directly driven by a laser beam.

11. A method for igniting an Inertial Confinement Fusion (ICF) target, the method comprising:
an ICF target comprising:
a central region, wherein said central region receives a fusion fuel mixture;
a first shell, wherein said first shell comprises a plurality of materials having a Z greater than 48 and having an areal density of less than approximately 4 g/cm²;
an outer shell, wherein said outer shell surrounds said first shell;
supporting said ICF target within a hohlraum; and
reducing a temperature at which the first shell is bleached to less than approximately 4.9 KeV.

12. The method of claim 11, wherein the ICF target further comprises a second shell concentrically located between said first shell and said outer shell.

13. The method of claim 12, wherein the first shell and the second shell of the ICF target further comprises a plurality of materials, in a laminated, mixed or layered fashion.

14. The method of claim 13, wherein the second shell further comprises a material having a Z of 5 and below.

15. The method of claim 14, further comprising: reducing the areal density of the first shell of the ICF target to less than approximately 0.4 g/cm².

16. The method of claim 15, further comprising: reducing a temperature at which the first shell is bleached to less than approximately 3.0 KeV.

17. The method of claim 16, further comprising: reducing the areal density of the first shell of the ICF target to less than approximately 0.2 g/cm².

18. The method of claim 13, wherein the material of the first shell is non-fissile fissionable material.

19. The method of claim 13, wherein the material of the first shell is tungsten.

20. The method of claim 11, further comprising: directly driving the ICF target only by a laser beam.
